(19) United States
(12) Patent Application Publication
(10) Pub. No.: US 2018/0181974 A1
(43) Pub. Date: Jun. 28, 2018

(54) Methods and Systems for Performing Pricing Comparisons of Complex Layered or Tower Pricing Structures with Varying Pricing Components

(71) Applicant: AON GLOBAL OPERATIONS LTD (SINGAPORE BRANCH), Singapore (SG)

(72) Inventors: Emma LYNCH, Mountjoy (IE); Barry DILLON, Dublin (IE); Martina NAUGHTON, Dublin (IE)

(73) Assignee: AON GLOBAL OPERATIONS LTD (SINGAPORE BRANCH), Singapore (SG)

(21) Appl. No.: 15/852,260

(22) Filed: Dec. 22, 2017

Related U.S. Application Data
(60) Provisional application No. 62/438,723, filed on Dec. 23, 2016.

(51) Int. Cl. G06Q 30/02; G06Q 40/08; G06F 17/18

(52) U.S. Cl. CPC G06Q 30/0206; G06F 17/18; G06Q 40/08

(57) ABSTRACT

In an illustrative embodiment, methods and systems for modeling a layered or tower pricing program based upon limited layered or tower pricing structure data includes accessing pricing structure data having a number of layers, determining a base curve algorithm for representing an estimation of an optimally efficient pricing structure based upon the pricing structure data, the base curve algorithm representing a statistical distribution, and calculating, using the base curve algorithm and the pricing structure data, a fitted curve fitted to attachment points of the pricing structure data. The fitted curve may be used to estimate layer information and missing data points within one or more layers of the pricing structure data. By repeating the process for a number of competitors, peer comparison data may be generated to present comparisons of otherwise incompatible layered or tower pricing programs.

### RELATED APPLICATIONS

This application claims priority to U.S. Provisional Patent Application Ser. No. 62/438,723, entitled “Methods and Systems for Performing Pricing Comparisons of Complex Layered or Tower Pricing Structures with Varying Pricing Components,” filed Dec. 23, 2016, which is hereby incorporated by reference in its entirety.

### BACKGROUND

Some purchases, such as service provider pricing models or customized end-to-end product purchase models (e.g., product, installation, and maintenance), involve layered or tower pricing structures. In a particular example, reinsurance policies may include a proportional reinsurance share in the risk for a number of different risks covered by the policy. Layered or tower pricing structures are individualized, including different numbers of layers and different valuing models. For this reason, there is no straightforward comparison of one vendor's layered or tower pricing structure to another vendor's layered or tower pricing structure. Further to the aforementioned example, different reinsurance policies can cover different numbers of risk at different shares, creating difficulties in both comparison shopping and in benchmarking pricing solutions against competitor offerings.

Because of differences in layered or tower pricing structures, conventionally, no method of direct comparison has been available. Instead, vendors would need to attempt to determine marketplace tolerances for retentions, limits, and costs. These variables may be tweaked based on actuarial analysis and/or catastrophic models (in the example of reinsurance) for determining anticipated outcomes in service usage. However, no mechanism existed to confirm that each layer was appropriately or optimally priced throughout the layer or tower pricing structure.

Further, historically, little information has been available to determine whether pricing structures are competitive among peers. Lack of visible data regarding actively traded services using layered or tower pricing structures has led to little comprehension of market pricing trends. Further, any data that is publicly available is almost always not directly comparable due to the individualized nature of the layered or tower pricing structures. The only option available to service providers has been to charge similar prices for layers based on similar risks in similar geographic regions and loss distributions, which results in a “follow the leader” structuring rather than providing varying market options. Further, this follow the leader solution may prove difficult to market to service partners, such as different carriers involved in reinsuring layers of the layer or tower pricing structure, who each have individualized goals and target risk acceptance.

The inventors identified a need for swiftly and accurately generating comparison data between layered or tower pricing structures for use in peer benchmarking and in analysis of a provider's own layered or tower pricing structure solution. Further, the inventors developed a solution that is tolerant of gaps in known data elements of each layer or tower pricing structure. The solution, in some embodiments, is scalable without a large storage or processing footprint due to converting layered or tower pricing models to a truncated table format.

### SUMMARY OF ILLUSTRATIVE EMBODIMENTS

In one aspect, the present disclosure relates to modeling layered or tower pricing structures to allow for an apples-to-apples comparison between a vendor's pricing structure and peer offerings. The solution begins with applying an actuarial pricing methodology, referred to herein as an “Increased Limit Factors” (ILF), to resolve missing information in either the vendor data or each peer's data and to support accurate comparison modeling of layered or tower pricing structures. In the ILF approach, a curve is identified, for example through iterative comparison, to best represent the ratio of the expected cost of a desired policy limit to the cost of a basic limit over a range of pricing layers, representing different loss probabilities. The curve is then fitted, by the computing algorithm, to available data to represent the layered or tower pricing structure along a continuum. In some embodiments, missing layers are estimated through proportionally scaling back limits to fit between surrounding layers or weight participation percentages to maintain ratios but retain a total participation of 100 percent. To provide such estimates, for example, the ILF curve-fitting approach may infer a continuous distribution that represents which price is appropriate at any given level in a tower.

In one aspect, using inference of appropriate prices at given levels of each layered or tower pricing structure, methods and systems described herein develop benchmarking comparisons using virtual attachment points to supply accurate apples-to-apples comparisons between a vendor's pricing solution and peer pricing solutions. Further, through aggregating data at virtual attachment points, marketplace trends may be followed. In some embodiments, ILF curves are fitted for a large number of peer layered or tower pricing structures within a benchmarking system. In some embodiments, the systems and methods transform peer pricing data into curve representations and then aggregate data points obtained through curve analysis to determine estimated average or median values for layer pricing across a peer distribution. The benchmarking data may further be presented as a graphical user interface to an end user to provide visual comparison, aiding in the end user's understanding of the pricing comparisons.

The data, in some embodiments, is automatically obtained from a transactional program through merging transactional data from individual transactions involving a same product to obtain pricing information over multiple layers of the layered or tower pricing structure for each peer. In some embodiments, to reduce processing and storage requirements, ILF tables may be calculated to represent the cost ratio at select, estimated layer limits (e.g., virtual attachment points) in each layered or tower pricing structure of each peer within the benchmarking system such that these estimates may be used as benchmarking comparisons. For example, historic trend data may be maintained using minimized storage space through converting data derived at a number of virtual attachment points into tables of historic pricing points.

In one aspect, systems and methods of the present disclosure automatically analyze a partial layered or tower pricing structure to estimate missing values and to identify inconsistent values in real-time, presenting an optimized solution to a vendor for completing a layered or tower pricing structure offering. In some embodiments, the systems and methods involve transforming the ILF curve data into user interface graphics presenting comparison information between known (and estimated) data and calculated optimal data. The graphical analysis, in one example, can provide a user with the opportunity to recognize differences between layers of an actual (curve-fitted0 pricing structure and values of an optimal tower or pricing structure. For example, the end user may be presented with analytics suggesting areas where the layered tower or pricing structure is underpriced or overpriced within its attachment points.

The forgoing general description of the illustrative implementations and the following detailed description thereof are merely exemplary aspects of the teachings of this disclosure, and are not restrictive.

### BRIEF DESCRIPTION OF THE DRAWINGS

The accompanying drawings, which are incorporated in and constitute a part of the specification, illustrate one or more embodiments and, together with the description, explain these embodiments. The accompanying drawings have not necessarily been drawn to scale. Any values dimensions illustrated in the accompanying graphs and figures are for illustration purposes only and may or may not represent actual or preferred values or dimensions. Where applicable, some or all features may not be illustrated to assist in the description of underlying features. In the drawings:

FIG. 1 is a flow chart of an example method for developing data metrics and representing client data on an Increased Limit Factors curve;

FIG. 2A is a screenshot of an example user interface illustrating an actual premium per million curve representing client-provided data overlaid with a fitted Increased Limit Factors curve;

FIG. 2B is a screenshot of an example user interface illustrating a graphical comparison of client tower or layered pricing structure to a fitted or optimal pricing structure;

FIG. 2C is a screenshot of an example user interface illustrating a distribution of alpha parameters corresponding to all layered or tower pricing structures included in a chosen peer group of layered or tower pricing data;

FIG. 3 is a table illustrating example layered or tower pricing structure information;

FIG. 4 is a block diagram of an example computing system; and

FIG. 5 is a block diagram of an example distributing computing environment including a cloud computing environment.

### DETAILED DESCRIPTION OF ILLUSTRATIVE EMBODIMENTS

The description set forth below in connection with the appended drawings is intended to be a description of various, illustrative embodiments of the disclosed subject matter. Specific features and functionalities are described in connection with each illustrative embodiment; however, it will be apparent to those skilled in the art that the disclosed embodiments may be practiced without each of those specific features and functionalities.

The ILF curve, and its underlying statistical distribution, provides a tool for understanding claims severity at different loss probabilities. The shape of the curve—described by the parameter “alpha”—illustrates the rate at which price per unit of coverage drops off at increasingly unlikely loss outcomes. A higher alpha indicates a steeper curve, meaning that the price decreases more quickly for higher layers in a tower reinsurance pricing structure. Alpha is therefore a powerful way to characterize a tower or layered pricing structure with a single value. Thus, the inventors sought to calculate this parameter for a collection of reinsurance structures to support comparison of towers with differing structures.

Prior to finding the optimal value of the shape parameter for the curve, a baseline function is first selected to represent the underlying loss severity distribution. There are many statistical distributions that can be used to represent loss severity over a range of probabilities, the most common being the Pareto, gamma and lognormal curve families. The biggest challenge in finding the appropriate distribution lies in accurately reflecting both the frequent well-defined event severities and the tail event seventies that have very little historical data. After exploring the options, the inventors selected the Pareto distribution as a preferred embodiment for this purpose, due to its mathematical properties that make it generally acceptable fit to sparse data at both low and high severities in reinsurance losses. The Pareto function, as applied to a layered or tower pricing structure, describes the probability of a variable (e.g., layer cost) exceeding a given threshold. In this context, the shape therefore describes how quickly the probability of loss drops off at higher layers in the tower.

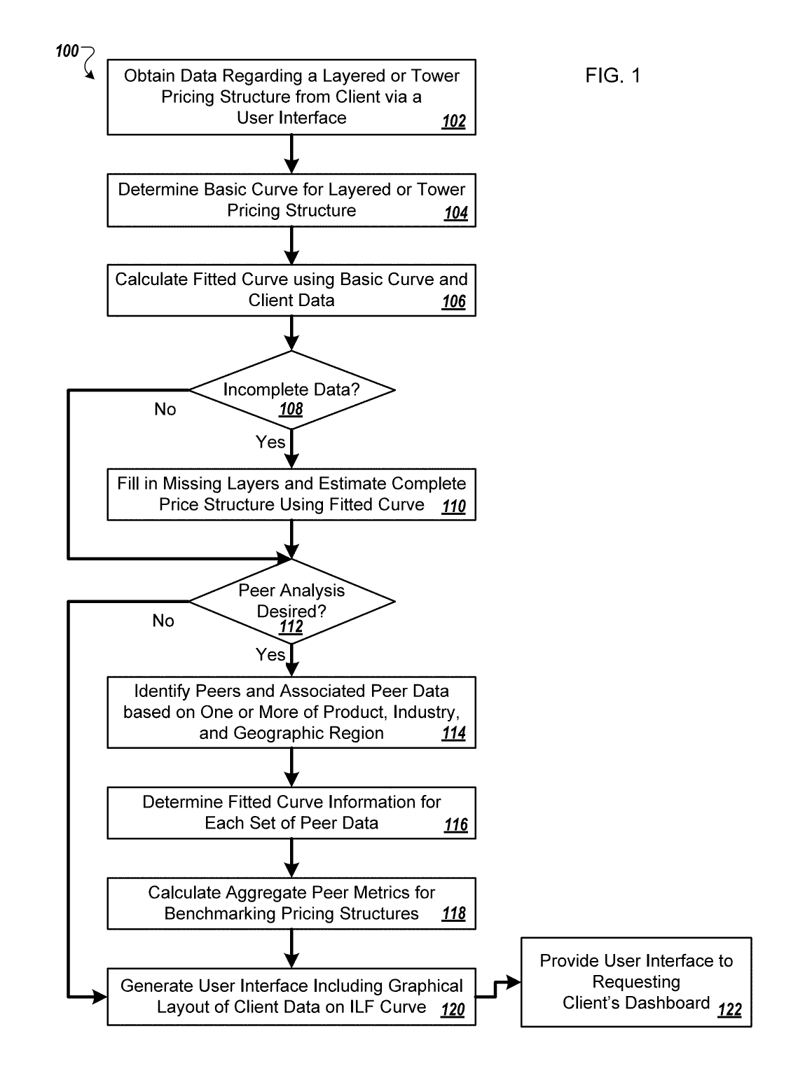

As each tower can be characterized by its particular shape parameter value, finding the appropriate alpha for as many layered or tower pricing structures as possible is valuable not only for determining pricing inefficiencies in individual pricing structures, but also for comparing towers and building up a market distribution of alpha for benchmarking. Using the rate of premium change provided by the ILF, the price, or the premium per million (ppm) of coverage can be represented via a user interface, for example to give brokers a new view of reinsurance programs that highlights pricing inefficiencies across the layered or tower pricing structure. An example method for developing data metrics and representing client data on an ILF curve is illustrated in FIG. 1.

The method of FIG. 1, in some implementations, begins with obtaining data regarding a layered or tower pricing structure from a client (102). In some circumstances, a subset of available trade-level data including layer components of pricing structures may be obtained from a company's internal database. This data can be presented to a user at a graphical user interface for completion by a user via user input. The client, in another example, may upload a file with layered or tower pricing structure data, such as a comma separated values (csv) file, via a user interface. The layered or tower pricing structure data, in some examples, can include, for each layer, a layer premium, a layer limit, and attachment point, a participation percent, an exposure base, an exposure variable, an exposure value, and an exposure value amount. In further examples, the layered or tower pricing structure data can include details such as a client name, an effective date, a trade country, a client country, one or more local products, one or more global products, and one or more carrier (e.g., insurer) names.

In some implementations, a base curve algorithm is selected based on the layered or tower pricing structure data provided by the client (104). The base curve algorithm, for example, can be used to represent an estimation of an optimally efficient pricing structure based upon the layered or tower pricing structure data. In a simplified version, a Pareto type III curve may be applied to most if not all layered or towered pricing data.

In some implementations, an optimal ILF curve is determined based on the layered or tower pricing structure data provided by the client (106). The optimal ILF curve may be determined by using the actual data points as discrete anchor points and fitting a Pareto function to those points to estimate a continuous curve that best describes the relationship between layer loss probability and price at every level of the tower structure. The fitting process produces Pareto curve parameters, such as α (tail index) and xm (minimum value of the random variable). Alpha, as mentioned before, sets the shape of the curve, while xm is a boundary parameter having an initial value set at the minimum positive attachment point (i.e., the start of the first layer of excess cover). Using the bounded Pareto function as a baseline, the fitted curve adjusts the function according to these parameters to create a representation of the pricing structure by capturing the relationship between loss probability and price. The fitted ILF curve is thus meant to estimate an optimally efficient pricing structure based upon the available layered or tower pricing structure data.

The layered pricing data may not be complete, however. For example, the client may only provide (or may only have access to) a portion of the information regarding the layered pricing structure, such as a top layer and a bottom layer. In another example, the client data may include conflicting coverage information. In some implementations, the provided layered or tower pricing structure is reviewed to identify any gaps or conflicts in the layer information provided. Conflicting coverage information often appears as different limits at the same attachment point or several partial layers whose aggregate participation percentages are greater than 100. In these cases, limits may be proportionally scaled back to fit between surrounding layers or weight participation percentages to maintain ratios but retain a total participation of 100 percent. These selections, for example, may be designed to give as much credit to the existing data as possible, while ensuring the fitted curve is more representative of accepted actuarial pricing methodologies. Gaps in data can make it difficult to visualize a complete structure for many reinsurance programs. The ILF curve fitting algorithm, however, provides the opportunity effectively fill in missing layers and estimate entire structures more accurately without requesting corrected input data from the client.

In some implementations, using the ILF curve, missing layers are filled in to estimate a complete price structure. In the case of missing layers in a tower or layered pricing structure, the only known variable is how much total limit is likely to be missing and where in the layered or tower pricing structure the gap is located. It is not possible to know how many layers belong in the gap, so it is not practical to create actual layers to fill the gap. Instead, the ILF curve-fitting process infers a continuous distribution that represents which price is appropriate at any given level in a tower. This allows the user to obtain a total premium estimate for a tower, regardless of gaps, that is based on the total limit and whatever attachment point data is available.

In some implementations, it is determined whether the client wishes to view a peer analysis of the layered or tower pricing structure. Accurate comparison of complex pricing structures between different providers is a major goal of the ILF algorithm and curve generation. The ILF algorithm has been designed to support comparison of layered or towered pricing structures, regardless of structural differences. For example, client data may be compared to peer information including differing number of layers and/or different layer components. The breadth of comparison afforded by the ILF algorithm allows for better insight into client value and can drive competition between reinsurance providers.

If peer analysis is desired (112), in some implementations, peers and associated peer data is identified (114). The peers, for example, may be identified based upon one or more carriers that supply the same product. The peers, additionally, may be identified as carriers that compete for business within the same industry and/or the same geographic region. Further, relevant peer data is obtained for each of the identified peer carriers. The relevant peer data can include a same or similar product involving a same or similar pricing structure. In a preferred embodiment, a goal of the layer pricing optimizer is to enable the user to set the parameters that define a peer group, giving them agency over which layered or tower pricing structures become the basis for a market to use as a benchmark for pricing structures. The relevant peer data may be identified based upon transactional information (e.g., completed reinsurance policy transactions) collected by a reinsurance exchange platform. The peer data may be time constrained to identify current pricing policies. In one example, pricing structures related to policies purchased within the past month, fiscal quarter, six-month, or one-year time period may be reviewed to identify relevant pricing structures to the client's layered or structured pricing program. In another example, the peer analysis may involve presenting changes in pricing structures over time. This analysis may involve obtaining peer data from multiple fiscal quarters or years. The R programming language for statistical computing and graphics generation, in a preferred embodiment, may be used to fit each layered or tower pricing structure in a large peer group and obtain an optimal shape parameter for each. The optimal shape parameters can then be shown together in a distribution of alphas that illustrates how the price-to-risk relationship is characterized across a peer group.

If peer data is identified for peers in a variety of geographic regions, the layered or tower pricing structure data may be adjusted to the client's local currency. For example, peer data may relate to trades occurring in a number of countries. The pricing information, for comparison, may be adjusted to present a common currency such as US dollars.

In some implementations, fitted curve information for each set of peer data is determined (116). Many curves may be generated for all identified layered or tower pricing structures associated with each identified peer carrier. For speed and efficiency, a scaled tool, hosted on a cloud server, may calculate ILF curves for all available peer layered or tower pricing structures (e.g., reinsurance pricing structures) on a nightly basis, while graphs and summary information on an individual pricing structure may be generated in real-time to render in a user interface. In this circumstance, identifying peer data (114) may include identifying and obtaining calculated peer ILF curves.

Alternatively, rather than fitting ILF curves for all layered or tower pricing structures, ILF tables may be calculated to represent the cost ratio at select layer limits in each layered or tower pricing structure. This would require, for example, developing a set of assumptions on all components of loss severity, and the process would then be limited by the discrete limits chosen for estimation and the lack of available data for tail loss probabilities (e.g. an extremely rare but severe loss event that is possible but has not occurred historically). The inventors opted to use the R programming language in the preferred embodiment due to its strength in the efficient computation of statistical optimization problems. This computational capability allowed them to address issues of sparse data and avoid the prohibitively taxing and time-consuming manual alternative. Using this approach, an approximate ILF ratio for all possible limits can be calculated for millions of layered or tower pricing structures in less than five minutes.

In some implementations, aggregate peer metrics are calculated for use in benchmarking pricing structures (118). For example, median layered pricing structure values may be determined for a given geographic region and/or timeframe (e.g., month, quarter, half year, year, etc.). Further, the benchmarking pricing structures may be analyzed per product. The layered or tower pricing structures included in the benchmarking analysis may be those that match the user specifications, such that the user effectively controls the degree of similarity that should be used as a baseline for peer benchmarking of layered or tower pricing structures.

In some implementations, graphical layout elements for a user interface are generated (120). For example, a layout of the client data with the fitted ILF curve may be provided to the client. Using the actual layer and price data provided by the client at step 102 and the fitted layered pricing structure provided by the ILF algorithm in step 106, the pricing curves for each may be compared to determine where they align on the trade-off between price and layer risk, and where they differ. This enables users to see whether the actual coverage for each layer of the layered or tower pricing structure is priced at a discount or premium, relative to the estimated efficient pricing structure. The fitted curve may allow brokers to assess a relative pricing structure to determine how much it would cost clients to increase or decrease coverage limits or identify layers that are prohibitively expensive due to their underlying risk.

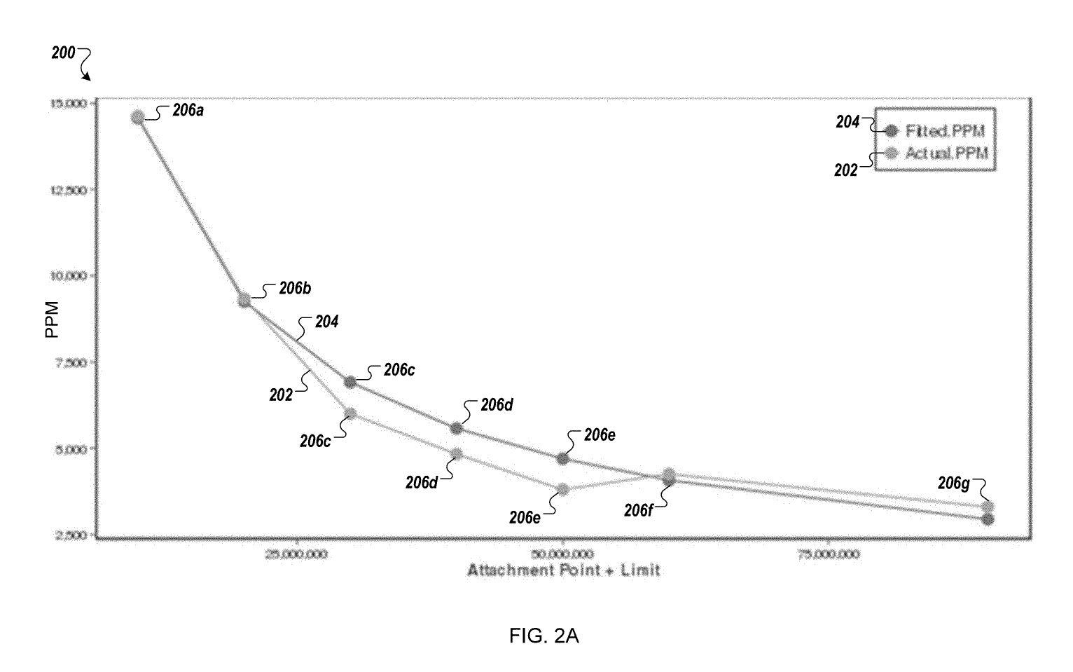

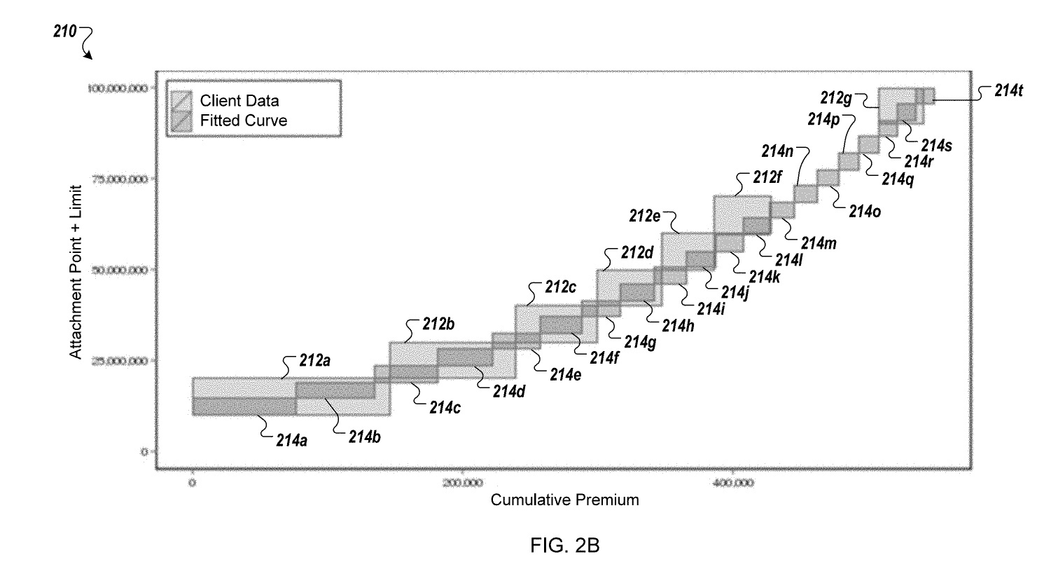

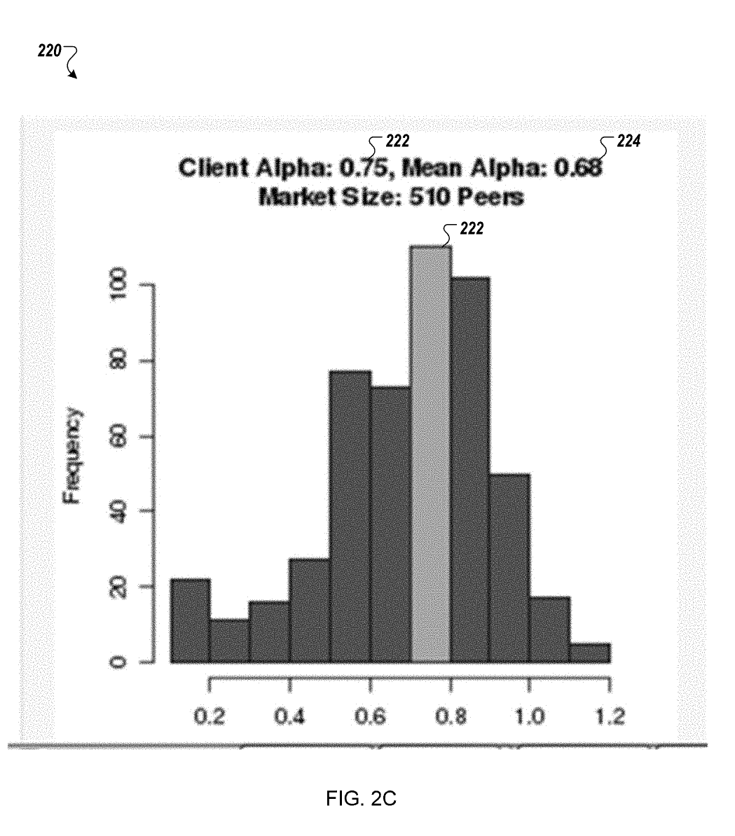

An example of this graphical output is illustrated in FIG. 2A. Turning to FIG. 2A, a screen shot 200 illustrates an actual premium per million curve 202 representing the client data overlaid with a fitted ILF curve 204 generated by computing parameters for the bounded Pareto function. Both curves 202, 204, as illustrated, are graphed over the available attachment points and limits in the layered or tower pricing structure. This figure plots the fitted PPM 204 with the client's actual PPM 202 at each layer 206 in the layered or tower pricing structure. Points where the green line is below the blue line represent those layers that are less expensive than the optimal curve, illustrating where the client is getting a discount. In reviewing the graph of FIG. 2A, for example, the client may determine that the pricing at attachment points 206c, 206d, and 206e between at least 25M and 50M are expensive, while the pricing at attachment points above at least 75M 206g are discounted.

Further, in the example of a request including gaps in the layered or tower pricing structure, the filled in missing layers are represented in a screen shot 210 of FIG. 2B. Turning to FIG. 2B, the screen shot 210 illustrates a comparison of actual client tower or layered pricing information (202) to the fitted or optimal (206) information. When fitting a curve to a layered or tower pricing structure, an alpha parameter may be derived that controls the shape of the curve and represents the rate at which PPM drops off as one travels up the layered or tower pricing structure. Using the graph of FIG. 2B, for example, the client can visualize the premium associated with each layer in the tower structure in the actual data presented in the boxes 212. They can also see (in boxes 214) the rate at which the premium drops off for the same limit amount at points in the tower corresponding to less likely loss probabilities. The boxes 214 illustrate a generic tower structure representing the shape that was found by fitting the Pareto function to the data in the boxes 212. This enables users to view what cost trade-offs would result from changing coverage limits or rearranging the tower structure.

For peer analysis, in some implementations the user is presented with a market view of fitted curves. A histogram screen shot 220 of FIG. 2C represents an example distribution of the alpha parameters for all layered or tower pricing structures included in a chosen peer group. The user can therefore see where an individual client's layered or tower pricing structure alpha 222 lands (e.g., higher or lower) than a mean alpha 224 for the peer group.

Returning to FIG. 1, in some implementations, the user interface is provided to the requesting client's dashboard (122). The user interface, for example, may include the graphical elements represented in FIGS. 2A through 2C. Additionally, the user interface may contain a number of elements for drilling down into the components of the ILF calculations and/or otherwise aiding in analysis of the data.

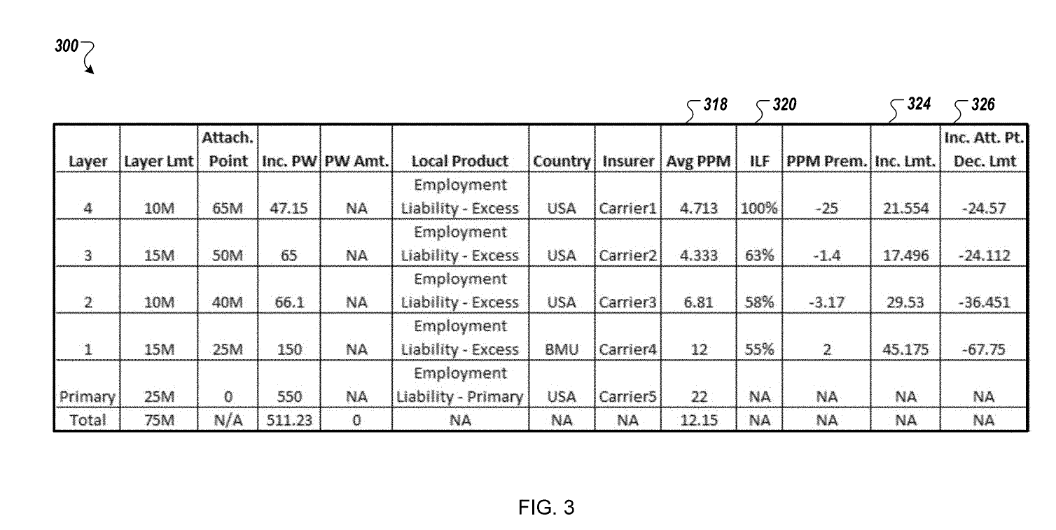

In illustration, FIG. 3 presents an example table 300 of layered or tower pricing structure information. The table 300 represents layers of a layered or tower pricing structure including details regarding the layer limit, attachment point, and premium provided in the client data. Further, each layer includes a local product name, a trade country, and an insurer name.

In the comparison analysis, an average PPM column 318 represents average price, or premium per million dollars of coverage for a given attachment point, while an ILF percentage 320 represents the ratio of the expected cost of the limit for a particular layer of coverage to the cost of the limit at the base reference layer. The “Increase Limits 5 m” column 324 refers to the amount in dollars that it would cost the client to increase the limit of this layer by 5 million. The “Increase Att. Pt/Decrease Limit 5 m” column 326 refers to the amount in dollars the client would save if they were to increase the attachment point (and hence decrease the overall limit) by 5 million. The user can project for a 1 million increase instead, in some embodiments, by unchecking a “use 5 m projected increase” checkbox (not illustrated) on the dashboard user interface.

Although the flow chart of FIG. 1 is described in relation to a client providing particular layered or tower pricing structure data for analysis, other applications of the ILF curve fitting methodology are envisioned. The true value of the layered or tower pricing optimizer tool is in its potential to leverage the quick large-scale fitting of ILF curves and the building of distributions of market pricing structures to construct an optimal layered or tower pricing structure with very little input from the user. For example, if a user could simply provide a total limit and approximate number and size of layers, it would be possible to build a pricing structure that a broker could use as a guideline prior to placement.

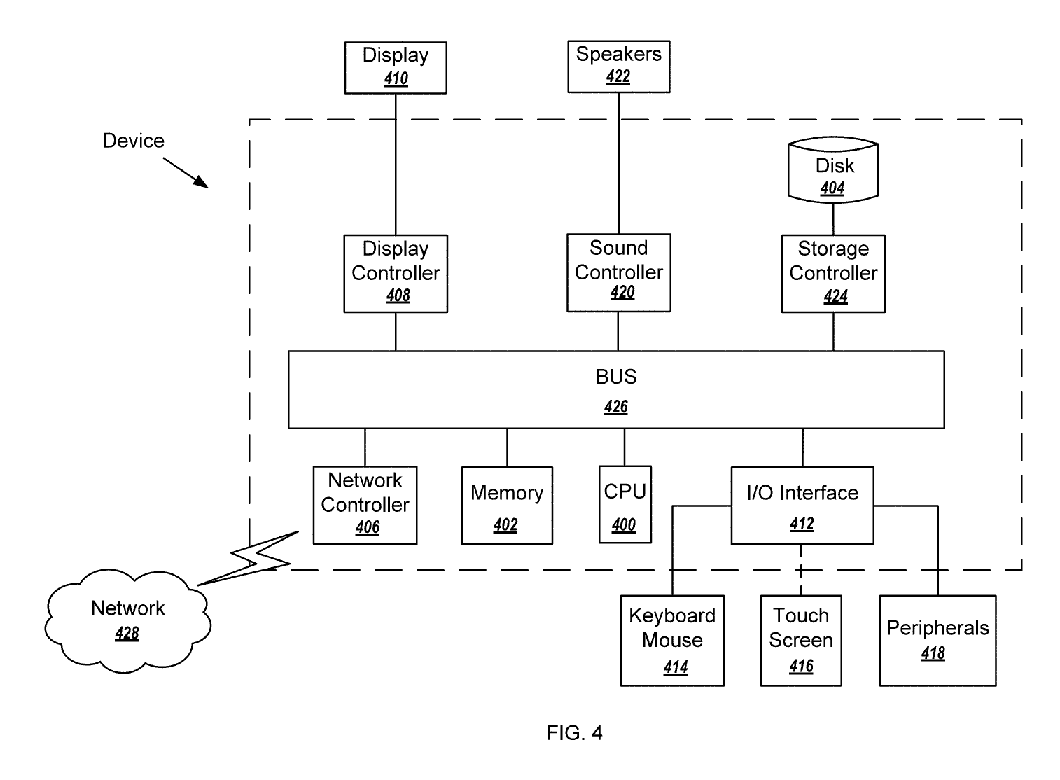

Next, a hardware description of the computing device, mobile computing device, or server according to exemplary embodiments is described with reference to FIG. 4. In FIG. 4, the computing device, mobile computing device, or server includes a CPU 400 which performs the processes described above. The process data and instructions may be stored in memory 402. These processes and instructions may also be stored on a storage medium disk 404 such as a hard drive (HDD) or portable storage medium or may be stored remotely. The CPU 400, for example, may provide the processing circuitry for performing the method 100 of FIG. 1. Further, the claimed advancements are not limited by the form of the computer-readable media on which the instructions of the inventive process are stored. For example, the instructions may be stored on CDs, DVDs, in FLASH memory, RAM, ROM, PROM, EPROM, EEPROM, hard disk or any other information processing device with which the computing device, mobile computing device, or server communicates, such as a server or computer. The memory, for example, may store tower or layered pricing structures such as the example pricing structure 300 of FIG. 3.

Further, a portion of the claimed advancements may be provided as a utility application, background daemon, or component of an operating system, or combination thereof, executing in conjunction with CPU 400 and an operating system such as Microsoft Windows 4, UNIX, Solaris, LINUX, Apple MAC-OS and other systems known to those skilled in the art.

CPU 400 may be a Xenon or Core processor from Intel of America or an Opteron processor from AMD of America, or may be other processor types that would be recognized by one of ordinary skill in the art. Alternatively, the CPU 400 may be implemented on an FPGA, ASIC, PLD or using discrete logic circuits, as one of ordinary skill in the art would recognize. Further, CPU 400 may be implemented as multiple processors cooperatively working in parallel to perform the instructions of the inventive processes described above.

The computing device, mobile computing device, or server in FIG. 4 also includes a network controller 406, such as an Intel Ethernet PRO network interface card from Intel Corporation of America, for interfacing with network 428. As can be appreciated, the network 428 can be a public network, such as the Internet, or a private network such as an LAN or WAN network, or any combination thereof and can also include PSTN or ISDN sub-networks. The network 428 can also be wired, such as an Ethernet network, or can be wireless such as a cellular network including EDGE, 3G and 4G wireless cellular systems. The wireless network can also be Wi-Fi, Bluetooth, or any other wireless form of communication that is known.

The computing device, mobile computing device, or server further includes a display controller 408, such as a NVIDIA GeForce GTX or Quadro graphics adaptor from NVIDIA Corporation of America for interfacing with display 410, such as a Hewlett Packard HPL2445w LCD monitor. A general purpose I/O interface 412 interfaces with a keyboard and/or mouse 414 as well as a touch screen panel 416 on or separate from display 410. General purpose I/O interface also connects to a variety of peripherals 418 including printers and scanners, such as an OfficeJet or DeskJet from Hewlett Packard. The display controller 408 and display 410, for example, may enable presentation of the screen shot 200 of FIG. 2A, the screen shot 210 of FIG. 2B, or the screen shot 220 of FIG. 2C.

A sound controller 420 is also provided in the computing device, mobile computing device, or server, such as Sound Blaster X-Fi Titanium from Creative, to interface with speakers/microphone 422 thereby providing sounds and/or music.

The general purpose storage controller 424 connects the storage medium disk 404 with communication bus 426, which may be an ISA, EISA, VESA, PCI, or similar, for interconnecting all of the components of the computing device, mobile computing device, or server. A description of the general features and functionality of the display 410, keyboard and/or mouse 414, as well as the display controller 408, storage controller 424, network controller 406, sound controller 420, and general purpose I/O interface 412 is omitted herein for brevity as these features are known.

One or more processors can be utilized to implement various functions and/or algorithms described herein, unless explicitly stated otherwise. Additionally, any functions and/or algorithms described herein, unless explicitly stated otherwise, can be performed upon one or more virtual processors, for example on one or more physical computing systems such as a computer farm or a cloud drive.

Reference has been made to flowchart illustrations and block diagrams of methods, systems and computer program products according to implementations of this disclosure. Aspects thereof are implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

Moreover, the present disclosure is not limited to the specific circuit elements described herein, nor is the present disclosure limited to the specific sizing and classification of these elements. For example, the skilled artisan will appreciate that the circuitry described herein may be adapted based on changes on battery sizing and chemistry, or based on the requirements of the intended back-up load to be powered.

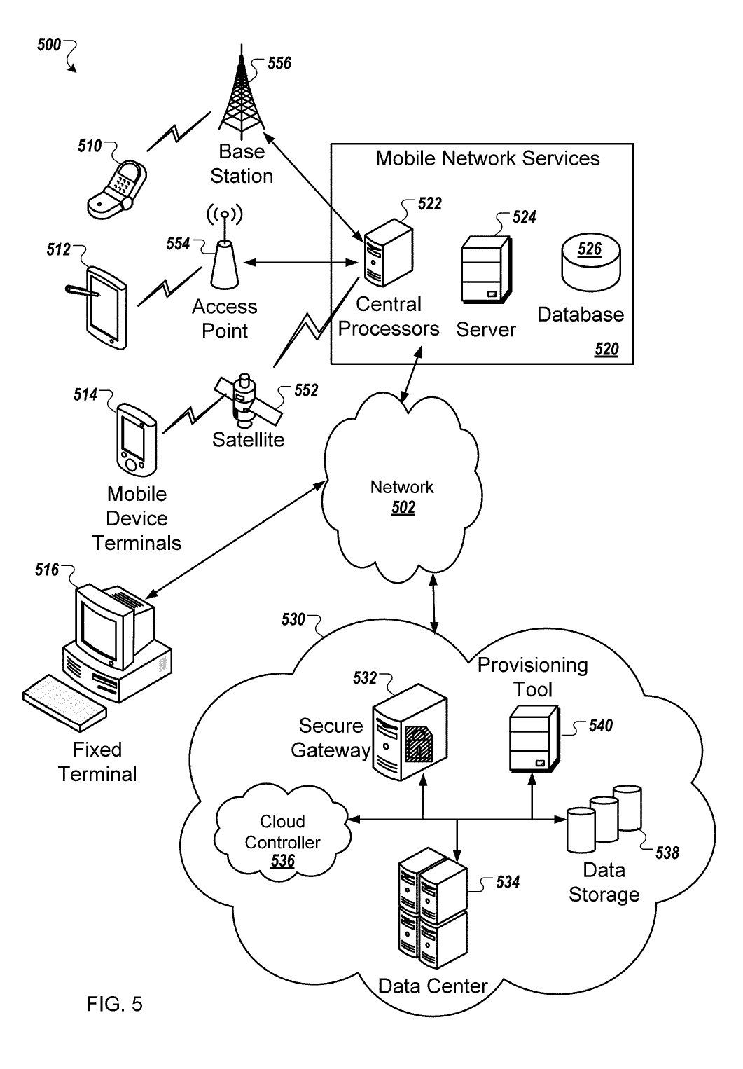

The functions and features described herein may also be executed by various distributed components of a system. For example, one or more processors may execute these system functions, wherein the processors are distributed across multiple components communicating in a network. The distributed components may include one or more client and server machines, which may share processing, as shown on FIG. 5, in addition to various human interface and communication devices (e.g., display monitors, smart phones, tablets, personal digital assistants (PDAs)). The network may be a private network, such as a LAN or WAN, or may be a public network, such as the Internet. Input to the system may be received via direct user input and received remotely either in real-time or as a batch process. Additionally, some implementations may be performed on modules or hardware not identical to those described. Accordingly, other implementations are within the scope that may be claimed.

In some implementations, the described herein may interface with a cloud computing environment 530, such as Google Cloud Platform™ to perform at least portions of methods or algorithms detailed above. The processes associated with the methods described herein can be executed on a computation processor, such as the Google Compute Engine by data center 534. The data center 534, for example, can also include an application processor, such as the Google App Engine, that can be used as the interface with the systems described herein to receive data and output corresponding information. The cloud computing environment 530 may also include one or more databases 538 or other data storage, such as cloud storage and a query database. In some implementations, the cloud storage database 538, such as the Google Cloud Storage, may store processed and unprocessed data supplied by systems described herein. As discussed above, the cloud computing environment 530 may support scalable processing of layered or tower pricing structures of multiple participants of a transactional platform. The pre-processing of some data (e.g., peer data for analysis), for example, may enable real-time responses to users evaluating layered or tower pricing structures.

The systems described herein may communicate with the cloud computing environment 530 through a secure gateway 532. In some implementations, the secure gateway 532 includes a database querying interface, such as the Google BigQuery platform.

The cloud computing environment 102 may include a provisioning tool 540 for resource management. The provisioning tool 540 may be connected to the computing devices of a data center 534 to facilitate the provision of computing resources of the data center 534. The provisioning tool 540 may receive a request for a computing resource via the secure gateway 532 or a cloud controller 536. The provisioning tool 540 may facilitate a connection to a particular computing device of the data center 534.

A network 502 represents one or more networks, such as the Internet, connecting the cloud environment 530 to a number of client devices such as, in some examples, a cellular telephone 510, a tablet computer 512, a mobile computing device 514, and a desktop computing device 516. The network 502 can also communicate via wireless networks using a variety of mobile network services 520 such as Wi-Fi, Bluetooth, cellular networks including EDGE, 3G and 4G wireless cellular systems, or any other wireless form of communication that is known. In some embodiments, the network 502 is agnostic to local interfaces and networks associated with the client devices to allow for integration of the local interfaces and networks configured to perform the processes described herein.

Reference throughout the specification to “one embodiment” or “an embodiment” means that a particular feature, structure, or characteristic described in connection with an embodiment is included in at least one embodiment of the subject matter disclosed. Thus, the appearance of the phrases “in one embodiment” or “in an embodiment” in various places throughout the specification is not necessarily referring to the same embodiment. Further, the particular features, structures or characteristics may be combined in any suitable manner in one or more embodiments. Further, it is intended that embodiments of the disclosed subject matter cover modifications and variations thereof.

It must be noted that, as used in the specification and the appended claims, the singular forms “a,” “an,” and “the” include plural referents unless the context expressly dictates otherwise. That is, unless expressly specified otherwise, as used herein the words “a,” “an,” “the,” and the like carry the meaning of “one or more.” Additionally, it is to be understood that terms such as “left,” “right,” “top,” “bottom,” “front,” “rear,” “side,” “height,” “length,” “width,” “upper,” “lower,” “interior,” “exterior,” “inner,” “outer,” and the like that may be used herein merely describe points of reference and do not necessarily limit embodiments of the present disclosure to any particular orientation or configuration. Furthermore, terms such as “first,” “second,” “third,” etc., merely identify one of a number of portions, components, steps, operations, functions, and/or points of reference as disclosed herein, and likewise do not necessarily limit embodiments of the present disclosure to any particular configuration or orientation.

Furthermore, the terms “approximately,” “about,” “proximate,” “minor variation,” and similar terms generally refer to ranges that include the identified value within a margin of 20%, 10% or preferably 5% in certain embodiments, and any values therebetween.

All of the functionalities described in connection with one embodiment are intended to be applicable to the additional embodiments described below except where expressly stated or where the feature or function is incompatible with the additional embodiments. For example, where a given feature or function is expressly described in connection with one embodiment but not expressly mentioned in connection with an alternative embodiment, it should be understood that the inventors intend that that feature or function may be deployed, utilized or implemented in connection with the alternative embodiment unless the feature or function is incompatible with the alternative embodiment.

While certain embodiments have been described, these embodiments have been presented by way of example only, and are not intended to limit the scope of the present disclosures. Indeed, the novel methods, apparatuses and systems described herein can be embodied in a variety of other forms; furthermore, various omissions, substitutions and changes in the form of the methods, apparatuses and systems described herein can be made without departing from the spirit of the present disclosures. The accompanying claims and their equivalents are intended to cover such forms or modifications as would fall within the scope and spirit of the present disclosures.

What is claimed is:

1. A method for constructing a continuous pricing curve using layered or tower pricing data points, comprising:
accessing layered or tower pricing structure data of a first entity, the layered or tower pricing structure data comprising a plurality of pricing layers, each pricing layer comprising a plurality of fields including a layer premium, a layer limit, and an attachment point;
determining, by processing circuitry using the layered or tower pricing structure data, a base curve algorithm for representing an estimation of an optimally efficient pricing structure based upon the layered or tower pricing structure data, wherein the base curve algorithm represents a statistical distribution;
calculating, by the processing circuitry using the base curve algorithm and the layered or tower pricing structure data, a fitted curve fitted to a plurality of the attachment points of the layered or tower pricing structure data;
determining, by the processing circuitry, a plurality of peer entities;
accessing peer layered or tower pricing structure data for each of the plurality of peer entities, wherein the respective peer layered or tower pricing structure data comprises structuring differences from the layered tower or pricing structure data;
for each peer of the plurality of peer entities, calculating, by the processing circuitry, comparative pricing structure data using the base curve algorithm and the respective peer layered or tower pricing structure data; and
presenting, for user review, a graphical comparison of the comparative pricing structure data and a representation of data derived from the fitted curve.

2. The method of claim 1, further comprising:
determining at least one field of at least one layer of the plurality of layers is missing a corresponding value; and
scaling related values to estimate the corresponding value.

3. The method of claim 1, further comprising:
determining at least one field of at least one layer of the plurality of layers comprises a first value conflicting with a second value of a different layer of the plurality of layers; and
proportionally adjusting related values while maintaining ratios between values to retain 100 percent participation rate.

4. The method of claim 1, wherein accessing the layered or tower pricing structure data comprises presenting known values of a portion of the plurality of fields at a user interface having user entry controls for supplying one or mussing values.

5. The method of claim 1, wherein:
the base curve algorithm is a Pareto algorithm; and
calculating the fitted curve comprises
identifying values of at least a portion of the plurality of layers as the attachment points, and
fitting the Pareto algorithm to the attachment points,
wherein fitting produces Pareto curve parameters including alpha.

6. The method of claim 1, wherein the comparative pricing structure data comprises alpha values for each of the plurality of peer entities.

7. The method of claim 1, wherein calculating the comparative pricing structure data comprises calculating, for each peer of the plurality of peer entities, a table representing cost ratios at selected layer limits.

8. The method of claim 1, wherein presenting the graphical comparison of the comparative pricing structure data comprises aggregating values for the plurality of peer entries.

9. The method of claim 1, wherein determining the plurality of peer entities comprises determining, from a plurality of member entities of a transactional platform, the plurality of peer entities as offering a same or similar product to the layered or tower pricing structure.

10. The method of claim 1, wherein accessing the peer layered or tower pricing structure data comprises identifying the peer layered or tower pricing structure data within a predetermined timeframe.

11. A non-transitory computer readable medium having instructions stored thereon, wherein the instructions, when executed by processing circuitry, cause the processing circuitry to:
access layered or tower pricing structure data of a first entity, the layered or tower pricing structure data comprising a plurality of pricing layers, each pricing layer comprising a plurality of fields including a layer premium, a layer limit, and an attachment point;
determine, using the layered or tower pricing structure data, a base curve algorithm for representing an estimation of an optimally efficient pricing structure based upon the layered or tower pricing structure data, wherein
the base curve algorithm represents a statistical distribution;
fit the base curve algorithm to the attachment points of the layered or tower pricing structure data to generate a fitted curve, wherein fitting produces a plurality of curve parameters including alpha;
generate a visual comparison of a plurality of optimally efficient attachment points along the base curve algorithm and the attachment points on the fitted curve; and
present, to a graphical user interface of a computing device, the visual comparison.

12. The non-transitory computer readable medium of claim 11, wherein accessing the layered or tower pricing structure comprises obtaining the layered or tower pricing structure from a database.

13. The non-transitory computer readable medium of claim 11, wherein the instructions, when executed by the processing circuitry, cause the processing circuitry to:
Identify one or more values missing within the layered or tower pricing structure data; and
Estimate each of the one or more values by inferring continuous distribution along the fitted curve.

14. The non-transitory computer readable medium of claim 11, wherein accessing the layered or tower pricing data comprises identifying, through completed transaction records on a transactional platform, at least a portion of the layered or tower pricing data.

15. The non-transitory computer readable medium of claim 11, wherein the layered or tower pricing structure data comprises a geographic region.

16. A system comprising:
processing circuitry; and
a non-transitory computer readable data store having instructions stored thereon;
wherein the instructions, when executed by the processing circuitry, cause the processing circuitry to
access a plurality of sets of layered or tower pricing structure data, the layered or tower pricing structure data comprising a plurality of pricing layers, each pricing layer comprising a plurality of fields including a layer premium, a layer limit, and an attachment point, wherein
structural differences exist between sets of layered or tower pricing structure data such that the plurality of sets of layered or tower pricing structure data are incompatible for direct comparison,
for each of the plurality of sets of layered or tower pricing structure data
determine, using the respective layered or tower pricing structure data, a base curve algorithm for representing an estimation of an optimally efficient pricing structure based upon the respective layered or tower pricing structure data, wherein
the base curve algorithm represents a statistical distribution, and
fit the base curve algorithm to the attachment points of the layered or tower pricing structure data to generate a fitted curve, wherein fitting produces a plurality of curve parameters including alpha,
across the plurality of sets of layered or tower pricing structure data, aggregate metrics derived in part from the respective fitted curves, and
cause presentation, on a display of a computing device, of a visual comparison of at least one of a) aggregated curve parameter metrics and the respective curve parameter of at least one of the plurality of sets of layered or tower pricing structure data, and b) aggregate pricing metrics and a corresponding pricing metric of the at least one of the plurality of sets of layered or tower pricing structure data.

17. The system of claim 16, wherein the plurality of sets of layered or tower pricing structure data comprises layered or tower pricing structure data of a same entity over time.

18. The system of claim 16, wherein:
the plurality of sets of layered or tower pricing structure data comprises layered or tower pricing structure data of a plurality of entities over time; and
the layered or tower pricing structure data is obtained through accessing records of completed transactions from a transactional platform.

19. The system of claim 16, wherein the presentation comprises a visual comparison of changes in peer layered or pricing structures over time to changes in layer or tower pricing structures over time for a selected entity.

20. The system of claim 16, wherein the aggregated curve parameter metrics comprise a distribution of peer alpha values in comparison to an alpha value for a selected entity.
